(19) United States
(12) Patent Application Publication
(10) Pub. No.: US 2019/0026993 A1
(43) Pub. Date: Jan. 24, 2019

(54) ELECTRONIC GAMING MACHINE, SYSTEM, AND METHOD FOR PROVIDING A THREE CARD FLUSH GAME

(71) Applicant: Gustavo Gerald Toja Frachia, Coral Gables, FL (US)

(72) Inventor: Gustavo Gerald Toja Frachia, Coral Gables, FL (US)

(21) Appl. No.: 15/719,907

(22) Filed: Sep. 29, 2017

Related U.S. Application Data
(60) Provisional application No. 62/604,796, filed on Jul. 21, 2017.
(60) Provisional application No. 62/604,847, filed on Jul. 24, 2017.
(60) Provisional application No. 62/604,874, filed on Jul. 24, 2017.
(60) Provisional application No. 62/542,848, filed on Aug. 9, 2017.

(51) Int. Cl. G07F 17/32

(52) U.S. Cl. CPC G07F 17/3293; G07F 17/3288; G07F 17/3276; G07F 17/3244; G07F 17/323

(57) ABSTRACT

An electronic gaming machine, a system, and a method provide a wagering game to one or more players. At least one required wager is received from a player, and three player cards are dealt to the player. A community card is dealt to a community area. A suit of the community card determines a hierarchy of winning player hands available to be formed by the player. The player is able to use the community card to form a player hand in conjunction with the player cards. A wagering decision is received from the player. A determination is made whether the player hand matches one of a plurality of winning hands, and an award to be received by the player is determined based on the player hand matching one of the plurality of winning hands.

### CROSS-REFERENCE TO RELATED APPLICATIONS

The present application claims priority to U.S. Provisional Patent Application Ser. No. 62/604,796, filed Jul. 21, 2017, U.S. Provisional Patent Application Ser. No. 62/604,847, filed Jul. 24, 2017, U.S. Provisional Patent Application Ser. No. 62/604,874, filed Jul. 24, 2017, and U.S. Provisional Patent Application Ser. No. 62/542,848, filed Aug. 9, 2017, the entire disclosures of which are hereby incorporated by reference.

### FIELD OF THE DISCLOSURE

The present disclosure relates generally to wagering games, and more specifically, to an electronic gaming machine, a system, and a method for providing a three card flush game.

### BACKGROUND

A variety of card games have been developed over the years, such as poker and blackjack. One of the most popular poker games is Texas Hold 'Em poker. In Texas Hold 'Em poker, one or more standard 52 card poker decks are shuffled by a dealer and dealt to two or more players. In addition, a series of community cards are dealt in stages to a common location on a poker table. The community cards are usable by all players to form a hand in conjunction with the cards dealt to each individual player. However, some players may feel that Texas Hold 'Em and similar card games require complicated strategies and are not suitable for casual players or novices. In addition, players often get bored with games that have been played the same way for years and desire new, fresh games that add excitement to their gameplay.

The present disclosure is aimed at solving one or more of the problems identified above.

### SUMMARY

In one embodiment, an electronic gaming machine includes a wager input device that accepts a physical item associated with a monetary value, and a player input device configured to receive an input representative of a wager amount from a player operating the electronic gaming machine, wherein the monetary value is added to a credit balance associated with the player and the wager amount is deducted from the credit balance. The electronic gaming machine also includes a cash out device configured to dispense at least a portion of the credit balance in the form of a physical object, a display device, and a processor. The processor is configured to provide a wagering game to the player, wherein the wagering game includes a virtual table displayed on the display device, receive an input associated with at least one required wager entered by the player, deal a set of three player cards to the player, and deal a community card to a community area of the virtual table, wherein the player is able to use the community card to form a player hand in conjunction with the set of player cards dealt to the player, and wherein a suit of the community card determines a hierarchy of winning player hands available to be formed by the player. The processor is also configured to receive a wagering decision from the player, determine whether the player hand matches one of a plurality of winning hands, and determine an award to be received by the player based on the player hand matching one of the plurality of winning hands. The processor is further configured to add the award to the credit balance of the player, receive an input from the player to initiate a cash out operation, and cause the cash out device to dispense at least a portion of the credit balance in the form of a physical object.

In another embodiment, a system includes a plurality of computing devices. Each computing device includes a player input device configured to receive an input representative of a wagering decision from a player operating the computing device, a display device configured to display a wagering game including a virtual table, and a processor configured to present the wagering game to the player on the display device. The system also includes a server coupled to each of the plurality of computing devices. The server includes a processor configured to provide the game to each computing device to cause each computing device of a plurality of computing devices to present the wagering game to a respective player of a plurality of players, and receive an input associated with at least one required wager entered by at least one player of the plurality of players, deal three player cards to the player, and deal a community card to a community area of the virtual table, wherein the player is able to use the community card to form a player hand in conjunction with the set of player cards dealt to the player, and wherein a suit of the community card determines a hierarchy of winning player hands available to be formed by the player. The server processor is also configured to receive a wagering decision from the player, determine whether the player hand matches one of a plurality of winning hands, and determine an award to be received by the player based on the player hand matching one of the plurality of winning hands.

In another embodiment, a method of providing a wagering game to a plurality of players includes receiving at least one required wager from a first player at a table, receiving a second required wager from a second player at the table, dealing three player cards to each of the first player and the second player, and dealing a community card to a community area of the table, wherein the first player is able to use the community card to form a first player hand in conjunction with the player cards dealt to the first player and the second player is able to use the community card to form a second player hand in conjunction with the player cards dealt to the second player, and wherein a suit of the community card determines a hierarchy of winning player hands available to be formed by the first player and the second player. The method also includes receiving a wagering decision from each of the first player and the second player, determining whether the first player hand matches one of a plurality of winning hands, determining whether the second player hand matches one of the plurality of winning hands, determining an award to be received by the first player based on the first player hand matching one of the plurality of winning hands, and determining an award to be received by the second player based on the second player hand matching one of the plurality of winning hands.

### BRIEF DESCRIPTION OF THE DRAWINGS

Advantages of the present disclosure will be readily appreciated, as the same becomes better understood by reference to the following detailed description, when considered in connection with the accompanying drawings. Non-limiting and non-exhaustive embodiments of the present disclosure are described with reference to the following figures, wherein like numerals refer to like parts throughout the various views unless otherwise specified.

FIG. 1 is a block diagram of a system that may be used to provide a wagering game to one or more players.

FIG. 2 is a block diagram of a system that may be used to provide a wagering game to one or more players using one or more electronic gaming machines.

FIG. 3 is a block diagram of electronic gaming machine components that may be used with the electronic gaming machines shown in FIG. 2.

FIG. 4 is a block diagram of another system that may be used to provide a wagering game to one or more players using one or more computing devices.

FIG. 5 is a block diagram of computing device components that may be used with the computing devices shown in FIG. 3.

### DETAILED DESCRIPTION

The systems and methods described herein provide a wagering game to a plurality of players. The wagering game may be implemented on one or more electronic gaming machines that are coupled to a server by a network. Alternatively, the wagering game may be implemented as an online game that is presented to one or more players on one or more computing devices coupled to a server. Still alternatively, the wagering game may be implemented on a physical table using physical or virtual cards.

In one embodiment, the wagering game presented to the players is a unique three card flush game. Alternatively, any suitable wagering game may be presented to the players. In one embodiment, the three card flush game is played by each player posting two initial mandatory wagers: a mandatory flush wager and a mandatory odds wager. After each player has posted the initial wagers, a set of three player cards is dealt face down to each player. In addition, one community card is dealt face down to community card area of the table. In one embodiment, the player cards and the community card are dealt from a standard 52 card poker deck and the hierarchy of the cards is the same as in a classical poker game (i.e., 2, 3, 4, 5, 6, 7, 8, 9, 10, J, Q, K, A). Alternatively, the player cards and the community card may be dealt from a non-standard 53 card poker deck or a deck having any suitable number of cards.

Each player may look at his or her own player cards but may not look at the community card. If, after reviewing the player cards, a player wishes to continue playing, the player must post the flush play wager. Otherwise, if the player does not wish to continue playing the game by posting the flush pay wager, the player will fold the hand and will forfeit the previously posted flush wager and odds wager. After all players have entered a wagering decision, the community card will be turned face up so that all players can see the card. The community card is then used along with each player's previously dealt player cards to form a four card player hand.

After the community card has been revealed, each player's hand is compared to a list of possible winning hands to determine whether that player's hand is a winning hand. If the player's hand is a winning hand, the player will receive the full amount of the flush wager and the flush pay wager previously posted by the player. In addition, the player receives an award or payout based on a ranking of the winning hand.

If the player is not able to form a winning hand using the player cards and the community card, the player forfeits the flush wager, the flush play wager, and the odds wager. After the winning hands and payouts have been determined, each player who has a winning hand receives the appropriate payout which is either credited to a credit balance associated with that player or is paid out in wagering chips or other forms of credit or currency. The game ends and a new game may begin as described above.

In one embodiment, while playing the three card flush game, each player may have an option to place a secondary wager in what is called an “envit” side wager. In the envit side wager option, the suit of the community card will alter a hierarchy of winning hands for the players. The outcome of the envit side wager is resolved along with the three card flush game using the same player and community cards used during the primary three card flush game.

When determining the outcome of the envit side wager, the player cards that match the suit of the community card are first determined. Once one or more player cards are determined to match the suit of the community card, the face value of the matching player cards are compared to the face value of the community card. If any of the player's matching cards has a higher value than the community card, the player wins the envit side wager and receives an envit payout that is separate from a payout that might be received from the primary three card flush game. However, if one or more of the player cards match the suit of the community card but do not have a higher face value than the community card, then the player will receive the full amount of the previously posted envit wager but will forfeit the envit play wager.

In another embodiment, while playing the three card flush game, each player may have an option to place another secondary wager in what is called a “wild plus” side wager. In one embodiment, the three card flush game may enable players to either place the wild plus side wager or the envit side wager, but not both. Alternatively, the three card flush game may enable players to place both the wild plus side wager and the envit side wager during the game. The outcome of the wild plus side wager is resolved along with the three card flush game using the same player and community cards.

When determining the outcome of the wild plus side wager, the player hand is compared to a list of possible winning hands for the wild plus side wager that is separate from the list of possible winning hands for the primary three card flush game.

Accordingly, after the community card has been revealed, each player's hand is compared to the list of possible winning hands to determine whether that player's hand is a winning hand. If the player's hand is a winning hand, the player will receive an award or payout based on a ranking of the winning hand. This award or payout is referred to as a “wild plus payout” since it is based on the wild plus wager previously posted by the player.

If the player is not able to form a winning hand using the player cards and the community card, the player forfeits the wild plus side wager. After the winning hands and payouts have been determined, each player who has a winning hand receives the appropriate payout which is either credited to a credit balance associated with that player or is paid out in wagering chips or other forms of credit or currency. The game ends and a new game may begin as described above.

Accordingly, the above-described three card flush game may provide increased excitement for players, while providing an easily understandable gameplay. The envit and wild plus side wagers also provide additional options to customize a player's gameplay of the three card flush game, which may further add to player excitement and enjoyment of the game.

Reference throughout this specification to “one embodiment”, “an embodiment”, “one example” or “an example” means that a particular feature, structure or characteristic described in connection with the embodiment of example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system”. Furthermore, the present invention may take the form of a computer program product embodied in any tangible media or expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Several (or different) elements discussed below, and/or claimed, are described as being “coupled”, “in communication with” or “configured to be in communication with”. This terminology is intended to be non-limiting, and where appropriate, be interpreted to include without limitation, wired and wireless communication using any one or a plurality of suitable protocols, as well as communication methods that are constantly maintained, are made on a periodic basis, and/or made or initiated on an as needed basis.

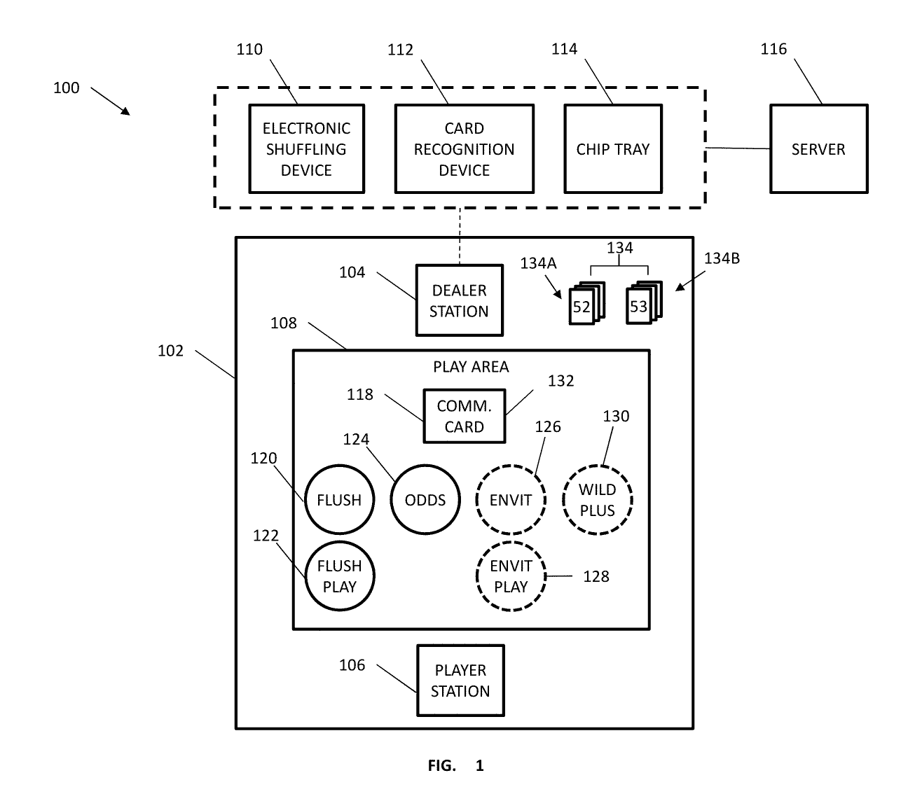

FIG. 1 is a block diagram of an exemplary system 100 that may be used to present a wagering game to one or more players. In the example illustrated in FIG. 1, the wagering game is presented as a table game played on a table 102. However, it should be recognized that the wagering game may be presented as a virtual or electronic game using one or more electronic gaming machines (EGMs), computing devices, servers, and/or other components of the systems described herein. In an embodiment, system 100 includes a physical table 102 that includes a dealer station 104, one or more player stations 106, and a play area 108 (sometimes referred to as a “board”).

In some embodiments, dealer station 104 includes an electronic shuffling device 110, a card recognition device 112, and a chip tray 114. Alternatively, dealer station 104 may not include one or more of the above-identified devices or components. In one embodiment, one or more of the dealer station devices or components may be communicatively coupled to one or more servers 116.

Electronic shuffling device 110 is configured to automatically shuffle one or more decks of playing cards. A dealer may specify the number of decks to be shuffled, in some embodiments, or electronic shuffling device 110 may be configured to shuffle a predefined number of decks. Electronic shuffling device 110 automatically shuffles the cards and provides the cards to the dealer to be dealt individually or in groups of cards having a predetermined number of cards (e.g., three cards). Electronic shuffling device 110 may communicate with server 116 to track a number of cards dealt or a number of decks shuffled, for example.

In one embodiment, card recognition device 112 includes an optical sensor for reading images of cards that pass over the optical sensor as the dealer deals the cards, for example. Alternatively, card recognition device 112 may include a wireless tag reader for reading electromagnetic tags embedded within the cards. The tag reader may be a radio frequency identification (RFID) reader that reads RFID tags embedded within the cards, a near-field communication (NFC) reader that reads NFC tags embedded within the cards, or any other suitable wireless tag reader. Card recognition device 112 may be a standalone device coupled to or integrated within table 102, or may be incorporated into electronic shuffling device 110 or another suitable device. Card recognition device 112 may communicate with server 116 to track each particular card that is dealt.

Chip tray 114 may be used for storing wagering chips that are used during the wagering game. In one embodiment, each wagering chip includes a wireless tag, such as an RFID or NFC tag, that identifies the denomination of the chip. Accordingly, chip tray 114 may include a wireless tag reader, such as an RFID or NFC tag reader, that automatically reads the tags of each chip stored within chip tray 114 and automatically identifies how many chips of each denomination is stored within chip tray 114. Chip tray 114 may transmit data representative of the identified chips and denominations to server 116 to enable server 116 to track the usage of the chips. Alternatively, chip tray 114 may not be used and wagering activity may occur instead using a touch screen device (not shown) integrated within, or positioned at each player station 106.

Player stations 106 are designated player positions around table 102 for each player playing the game. Each player station 106 may receive three player cards that are dealt to the player sitting (or standing) at the player station 106. Alternatively, any suitable number of player cards may be dealt to each player at each player station 106.

In one embodiment, each player station 106 may include a touch screen device (not shown) that is integrated within, or coupled to, table 102. In such an embodiment, the players may use the touch screen devices to enter wagers or other wagering decisions (e.g., call, fold, etc.). Additionally or alternatively, the touch screen devices may display the player cards as virtual cards within a screen of the touch screen device. Thus, instead of the dealer dealing physical player cards to each player at the player's respective player station 106, the cards may be virtually dealt to each player by server 116 or another suitable device and may be displayed on the respective player's touch screen device.

Play area 108 is a portion of table 102 that is designated for displaying a community card 118 that is dealt during the game as well as for placing wagering chips associated with each player's wagers. Specifically, the dealer may deal community card 118 into play area 108 so that each player may view community card 118 and use community card 118 to form a player hand as described more fully herein.

Server 116 is coupled to one or more devices of dealer station 104, in one embodiment. In addition, server 116 may be coupled to each touch screen device of each player station 106 in embodiments where the touch screen devices are used. Server 116 includes at least one processor (not shown) for controlling the operation of server 116 and for performing the functions of server 116 described herein. Server 116 may track the cards provided by electronic shuffling device 110 that are then dealt by the dealer, and may track the chips that are removed from chip tray 114 and that are then provided to each player. Accordingly, server 116 may audit the operation of the wagering game at table 102. Server 116 may also implement a player reward program, or may interface with a player reward server (not shown) that implements the program. In an embodiment where touch screen devices are used instead of chips for the players' wagering activities, server 116 may communicate with the touch screen devices to establish a credit balance for each player, receive the wagering decisions and associated wager amounts from the players, maintain a credit balance associated with each player, decrease each player's credit balance based on each player's wagering activity, increase a player's credit balance according to an amount won by the player, and/or may automatically credit or transfer currency corresponding to the player's credit balance to an electronic account (such as a bank account) when a player leaves the table or initiates a cash out operation through the touch screen device.

Play area 108 is adapted to enable one or more players to play a primary game of “three card flush” that is described more fully herein. Accordingly, unless otherwise specified, reference to “a game” or “the game” refers to the primary game of three card flush. Play area 108 includes designated locations for receiving wagers from each of the players during the three card flush game. For example, play area 108 includes a flush wager area 120, a flush play wager area 122, and an odds wager area 124 that are designated to receive a respective flush wager, a flush play wager, and an odds wager. Play area 108 may also include an optional envit wager area 126, an optional envit play wager area 128, and/or an optional wild plus wager area 130 that are designated to receive a respective envit wager, an envit play wager, and/or a wild plus wager. In an embodiment, the flush wager and odds wager are mandatory wagers that must be placed by a player for that player to participate in the primary game and to receive the player cards for the game. The flush play wager is a mandatory wager that must be placed by a player after the player has received his or her cards in order for the player to continue playing the game and to view community card 118. In one embodiment, the amount of the flush play wager is equal to the amount of the flush wager. The envit wager and envit play wagers are optional side wagers that the player may place in conjunction with the three card flush game as described more fully herein. In addition, the wild plus wager is another optional side wager that the player may place in conjunction with the three card flush game as described more fully herein. While play area 108 is illustrated in FIG. 1 as including a single area for receiving flush, odds, envit, and/or wild plus wagers from a single player, it should be recognized that each player station 106 may be associated with a separate area within play area 108 for receiving flush, odds, envit, and/or wild plus wagers from an associated player.

### Three Card Flush Game

During operation, the three card flush game is played by each player posting the mandatory flush and odds wagers. After each player has posted the initial wagers, a set of three player cards is dealt face down to each player from a deck 134 of cards. In addition, one community card 118 (or lead card) is dealt face down to a community card area 132 of play area 108. In one embodiment, the player cards and the community card are dealt from a standard 52 card poker deck 134A. The hierarchy of the cards are the same as in a classical poker game (i.e., 2, 3, 4, 5, 6, 7, 8, 9, 10, J, Q, K, A). Alternatively, in any of the embodiments described herein, the player cards and the community card may be dealt from a non-standard 53 card poker deck 134B as described more fully herein or a deck having any suitable number of cards.

Each player may look at his or her own player cards but may not look at the community card. If, after reviewing the player cards, a player wishes to continue playing, the player must post the flush play wager. Otherwise, if the player does not wish to continue playing the game by posting the flush pay wager, the player will fold the hand and will forfeit the previously posted flush wager and odds wager. After all players have entered a wagering decision (i.e., deciding to fold or deciding to post the flush play wager), the community card will be turned face up so that all players can see the card. The community card is then used along with each player's previously dealt player cards to form a four card player hand.

In one embodiment, the suit of the community card will determine a hierarchy of winning hands available to be matched by the player cards in each player's hand (in combination with the community card). An example list of possible winning hands is identified in Table 1.

TABLE 1
Example List of Possible Winning Hands for Three Card Flush Game

| Winning Hand | Condition for Attaining Winning Hand |
|---|---|
| Grand Straight Flush | A three-card straight flush with a community card |
| | matching that suit. |
| Simple Straight Flush | A three-card straight flush with a community card |
| | that does not match that suit. |
| 2-Leading Card | A three card straight with two cards matching the |
| Straight Flush | community card's suit. |
| 1-Leading Card | A three card straight flush with one card |
| Straight Flush | matching the community card's suit and the other |
| | two cards being the same suit. |
| Grand Flush | A three-card flush with a community card |
| | matching that suit. |
| Simple Flush | A three-card flush with a community card that |
| | does not match that suit. |
| 2-Leading Card Flush | A two-card flush and a community card that |
| | matches the flush's suit. |
| 1-Leading Card Flush | A two-card flush and a community card that |
| | matches the suit of the player's third card. |

Accordingly, after the community card has been revealed, each player's hand is compared to the list of possible winning hands to determine whether that player's hand is a winning hand. If the player's hand is a winning hand, the player will receive the full amount of the flush wager and the flush pay wager previously posted by the player. In addition, the player receives an award or payout based on a ranking of the winning hand. This award or payout is referred to as an “odds payout” since it is based on the odds wager previously posted by the player. An example pay table for the odds payout is shown below in Table 2.

TABLE 2
Example Pay Table for Three Card Flush Game based on Odds Wager

| Winning Hand | Payout |
|---|---|
| Grand Straight Flush | 100 to 1 |
| Simple Straight Flush | 50 to 1 |
| 2-Leading Card Straight Flush | 20 to 1 |
| 1-Leading Card Straight Flush | 20 to 1 |
| Grand Flush | 12 to 1 |
| Simple Flush | 5 to 1 |
| 2-Leading Card Flush | 2 to 1 |
| 1-Leading Card Flush | 1 to 1 |

If the player is not able to form a winning hand using the player cards and the community card, the player forfeits the flush wager, the flush play wager, and the odds wager. After the winning hands and payouts have been determined, each player who has a winning hand receives the appropriate payout which is either credited to a credit balance associated with that player or is paid out in wagering chips or other forms of credit or currency. The game ends and a new game may begin as described above.

The above described game play may be better understood with reference to non-limiting examples. In a first example, the player is dealt three player cards including a four of spades, a five of spades, and a six of spades. The community card is an ace of spades. Since the player has three player cards that are in sequence and that match the suit of the community card, the player has a winning hand of a Grand Straight Flush with a payout of 100 times the amount of the odds wager according to Table 2. The flush wager and the flush pay wager are also returned to the player.

In a second example, the player is dealt three player cards including a four of spades, a five of spades, and a six of spades. The community card is an eight of diamonds. Since the player has three player cards that are in sequence, but the cards do not match the suit of the community card, the player has a winning hand of a Simple Straight Flush.

In a third example, the player is dealt a four of diamonds, a five of spades, and a six of spades. The community card is an ace of spades. Since the player has two cards in sequence that match the suit of the community card, the player has a winning hand of a 2-Leading Card Straight Flush.

In a fourth example, the player is dealt a three of diamonds, a four of diamonds, and a five of spades. The community card is an ace of spades. Since the player has three cards in sequence with two cards of the same suit that do not match the suit of the community card, and one card that does match the suit of the community card (i.e., the five of spades), the player has a winning hand of a 1-Leading Card Straight Flush.

In a fifth example, the player is dealt an ace of spades, a six of spades, and a five of spades. The community card is a queen of spades. Since the player has three cards that have the same suit as the community card, but does not have all three player cards in sequence, the player has a winning hand of a Grand Flush.

In a sixth example, the player is dealt an eight of diamonds, a three of diamonds, and a seven of clubs. The community card is a four of diamonds. Since the player has two cards of the same suit that also match the suit of the community card, the player has a winning hand of a 2-Leading Card Flush.

In a seventh example, the player is dealt a five of spades, a four of diamonds, and an eight of diamonds. The leading card is an ace of spaces. Since the player has only one card that matches the suit of the community card but two other cards having the same suit as each other, the player has a winning hand of a 1-Leading Card Flush.

In an eighth example, the player is dealt an ace of spades, a six of spades, and a five of spades. The community card is a king of hearts. Since the player has three cards of the same suit that do not match the suit of the community card, the player has a winning hand of a Simple Flush.

In a ninth example, the player is dealt an ace of spades, a king of hearts, and a three of diamonds. The community card is a five of spades. Since the player is unable to make any flushes and thus cannot make any winning hands, the player loses the flush wager and the odds wager. Since the weakness of this hand should be apparent when the three player cards are dealt, the player would optimally fold after receiving the player cards instead of posting the flush play wager.

It should be recognized that the above described examples are for illustrative purposes only and are not limiting.

### Envit Side Wager

While playing the three card flush game, each player may have an option to place a secondary wager in what is called an “envit” side wager. In the envit side wager option, the suit of the community card will alter a hierarchy of winning hands for the players. The outcome of the envit side wager is resolved along with the three card flush game using the same player and community cards used during the primary three card flush game.

During play of the three card flush game that provides the envit side wager option, each player posts the mandatory flush and odds wagers. If any player wishes to place the optional envit side wager, that player must also post the envit wager at this time. After each player has posted the initial wagers, a set of three player cards is dealt face down to each player. The player cards may be dealt one by one to each player until all players have received three player cards, or may be dealt to each player as a set of three cards before dealing player cards to the next player. In addition, one community card 118 (or lead card) is dealt face down to community card area 132 of table 102. Each player may look at his or her own player cards but may not look at the community card. If, after reviewing the player cards, a player wishes to continue playing, the player must post the flush play wager. If the player had posted the initial envit wager, the player must also post the envit play wager to resolve the outcome of the side wager.

After the cards are revealed, the player's hand is evaluated based on the winning hands described above with reference to the three card flush game and any payout associated with the game is determined. In addition, the player's hand is evaluated to determine if the player wins the envit side wager.

When determining the outcome of the envit side wager, the player cards that match the suit of the community card are first determined. Once one or more player cards are determined to match the suit of the community card, the face value of the matching player cards are compared to the face value of the community card. If any of the player's matching cards has a higher value than the community card, the player wins the envit side wager and receives a separate envit payout. However, if one or more of the player cards match the suit of the community card but do not have a higher face value than the community card, then the player will receive the full amount of the previously posted envit wager but will forfeit the envit play wager.

The above described game play may be better understood with reference to non-limiting examples. In a first example, the player is dealt three player cards including an ace of spades, a four of diamonds, and an eight of diamonds. The community card is a five of spades. In the envit phase, the player looks for a card that matches the suit of the community card, in this example, the five of spades. As the player has the ace of spades, the player wins the envit side wagers (i.e., the envit wager and the envit play wager).

In a second example, the player is dealt an ace of spades, a four of diamonds, and an 8 of diamonds. The community card is a king of hearts. Since the suit of the community card is hearts, the player does not have any player cards having the same suit. As a result, the player loses the envit side wagers (i.e., the envit wager and the envit play wager).

In a third example, the player is dealt a five of spades, a four of diamonds, and an eight of diamonds. The community card is an ace of spades. The player has one card that has the same suit as the community card (the five of spades), but the player's five of spades is ranked lower than the ace of spades. As a result, the player loses the envit play wager but the envit wager is returned to the player as a push. It should be recognized that the above described examples are for illustrative purposes only and are not limiting.

### Wild Plus Side Wager

While playing the three card flush game, each player may have an option to place a secondary wager in what is called a “wild plus” side wager. In one embodiment, the three card flush game may enable players to either place the wild plus side wager or the envit side wager, but not both. Alternatively, the three card flush game may enable players to place both the wild plus side wager and the envit side wager during the game. The outcome of the wild plus side wager is resolved along with the three card flush game using the same player and community cards.

During play of the three card flush game that provides the wild plus side wager option, each player posts the mandatory flush and odds wagers. If any player wishes to place the optional wild plus side wager, that player must post the wild plus side wager at this time. After each player has posted the initial wagers, a set of three player cards is dealt face down to each player. The player cards may be dealt one by one to each player until all players have received three player cards, or may be dealt to each player as a set of three cards before dealing player cards to the next player. In addition, one community card 118 is dealt face down to community card area 132 of table 102. Each player may look at his or her own player cards but may not look at the community card. If, after reviewing the player cards, a player wishes to continue playing, the player must post the flush play wager. If the player had posted the initial wild plus side wager, the player does not need to place another wager to keep the wild plus side wager option in play. In addition, even if the player folds the player hand for the main three card flush game, in one embodiment, the player's wild plus side wager remains active and an outcome and any associated payout is resolved based on the combination of the community card and the player cards.

After the cards are revealed, the player's hand is evaluated based on the winning hands described above with reference to the three card flush game identified in Table 1 and any payout associated with the game is determined as set forth in Table 2. In addition, the player's hand is evaluated to determine if the player wins the wild plus side wager as set forth below.

When determining the outcome of the wild plus side wager, the player hand is compared to a list of possible winning hands for the wild plus side wager. An example list of possible winning hands for the wild plus side wager is identified in Table 3.

TABLE 3
Example List of Possible Winning Hands for Wild Plus Side Wager

| Winning Hand | Condition for Attaining Winning Hand |
|---|---|
| Wild Royal | An ace-high straight flush matching the suit of the |
| Straight Flush | community card. |
| Wild Straight | A straight flush (not ace-high) matching the suit of the |
| Flush | community card. |
| Wild Trips | Any three of a kind with one of the three cards |
| | matching the suit of the community card. |
| Wild Straight | Any straight where at least one of the three cards matches |
| | the suit of the community card. |
| Wild Flush | Any flush that matches the suit of the community card. |
| Wild Pair | Any one-pair hand where either of the two cards in the |
| | pair matches the suit of the community card. |
| Wild Single | Any hand where one of the three cards matches the |
| | suit of the community card and is higher in rank than the |
| | community card, with Aces counting as the highest rank. |

Accordingly, after the community card has been revealed, each player's hand is compared to the list of possible winning hands to determine whether that player's hand is a winning hand. If the player's hand is a winning hand, the player will receive an award or payout based on a ranking of the winning hand. This award or payout is referred to as a “wild plus payout” since it is based on the wild plus wager previously posted by the player. An example pay table for the wild plus payout is shown below in Table 4.

TABLE 4
Example Pay Table for Wild Plus Side Wager

| Winning Hand | Payout |
|---|---|
| Wild Royal Straight Flush | 100 to 1 |
| Wild Straight Flush | 50 to 1 |
| Wild Trips | 40 to 1 |
| Wild Flush | 6 to 1 |
| Wild Straight | 4 to 1 |
| Wild Pair | 3 to 2 |
| Wild Single | 1 to 1 |

If the player is not able to form a winning hand using the player cards and the community card, the player forfeits the wild plus side wager. After the winning hands and payouts have been determined, each player who has a winning hand receives the appropriate payout which is either credited to a credit balance associated with that player or is paid out in wagering chips or other forms of credit or currency. The game ends and a new game may begin as described above.

The above described game play may be better understood with reference to non-limiting examples. In a first example, the player is dealt an ace of spades, a four of diamonds, and a seven of clubs. The community card is a five of spades. Since one of the player cards (the ace of spades) has the same suit as the community card and has a higher rank than the community card, the player has a winning hand of a Wild Single.

In a second example, the player is dealt a queen of diamonds, a queen of spades, and a king of hearts. The community card is an eight of diamonds. Since the player has a pair of cards with one of the cards having the same suit as the community card, the player has a winning hand of a Wild Pair.

In a third example, the player is dealt an ace of spades, a six of spades, and a five of spades. The community card is a queen of spades. Since the player has a three card flush (all three cards of the same suit) and the cards match the suit of the community card, the player has a winning hand of a Wild Flush.

In a fourth example, the player is dealt a four of diamonds, a five of hearts, and a six of hearts. The community card is an ace of spades. Since the player has all three player cards in sequence (a straight) and only one of the cards has the same suit as the community card, the player has a winning hand of a Wild Straight.

In a fifth example, the player is dealt a seven of hearts, a seven of clubs, and a seven of diamonds. The community card is a six of hearts. Since the player has a three of a kind (three sevens) and one of the cards has the same suit as the community card, the player has a winning hand of a Wild Trips.

In a sixth example, the player is dealt a four of spades, a five of spades, and a six of spades. The community card is an ace of spades. Since the player has a sequence of cards that all have the same suit and that match the suit of the community card, the player has a winning hand of a Wild Straight Flush.

In a seventh example, the player is dealt a queen of hearts, a king of hearts, and an ace of hearts. The community card is a seven of hearts. Since the player has an ace-high sequence of cards that all have the same suit and that match the suit of the community card, the player has a winning hand of a Wild Royal Straight Flush.

It should be recognized that the above described examples are for illustrative purposes only and are not limiting.

### Three Card Flush Game with White Card

In an alternative embodiment, the three card flush game may be implemented using a non-standard deck of cards (e.g., deck 134B). In a specific embodiment, the deck of cards includes 53 cards, with a traditional set of 52 poker cards and one or more additional white cards. In one embodiment, the white card is blank on at least one side. Alternatively, the white card may have any suitable artwork, color, or other features that distinguishes it from the standard poker cards. It should be recognized that the embodiment of the three card flush game with the white card may also be played with the wild plus side wager. While the following embodiments are described as having a 53 card deck with one white card, it should be recognized that any suitable number of white cards may be provided and any suitable number of standard poker cards may be provided. Thus, in some embodiments, the non-standard deck may have more than one white card and may have less than 52 standard poker cards.

In an embodiment, if the player is dealt the white card along with two other player cards, the white card acts as a wild card that takes on the suit and rank of the community card. If the white card is dealt as the community card, the white card will act as an eight of hearts. Alternatively, the white card may act as any other suitable card when dealt as the community card.

In a first example of the three card flush game with the white card embodiment, the player is dealt a four of spades, the white card, and a six of spades. The community card is a five of spades. Accordingly, the white card takes on the rank and suit of the community card, thus acting as a five of spades. Since the player has three cards in sequence having the same suit as each other and as the suit of the community card, the player has a winning hand of a Grand Straight Flush.

In a second example of the three card flush game with the white card embodiment in conjunction with the wild plus side wager, the player is dealt a queen of diamonds, the white card, and a king of hearts. The community card is a queen of spades. Accordingly, the white card takes on the rank and suit of the community card, thus acting as a queen of spades. Since the player has a pair of cards with one of the cards having the same suit as the community card, the player has a winning hand of a Wild Pair.

In a third example of the three card flush game with the white card embodiment in conjunction with the wild plus side wager, the player is dealt the white card, a seven of clubs, and a seven of diamonds. The community card is a seven of hearts. Accordingly, the white card takes on the rank and suit of the community card, thus acting as a seven of hearts. Since the player has three of a kind with one of the cards having the same suit as the community card, the player has a winning hand of a Wild Trips.

It should be recognized that the above described examples are for illustrative purposes only and are not limiting.

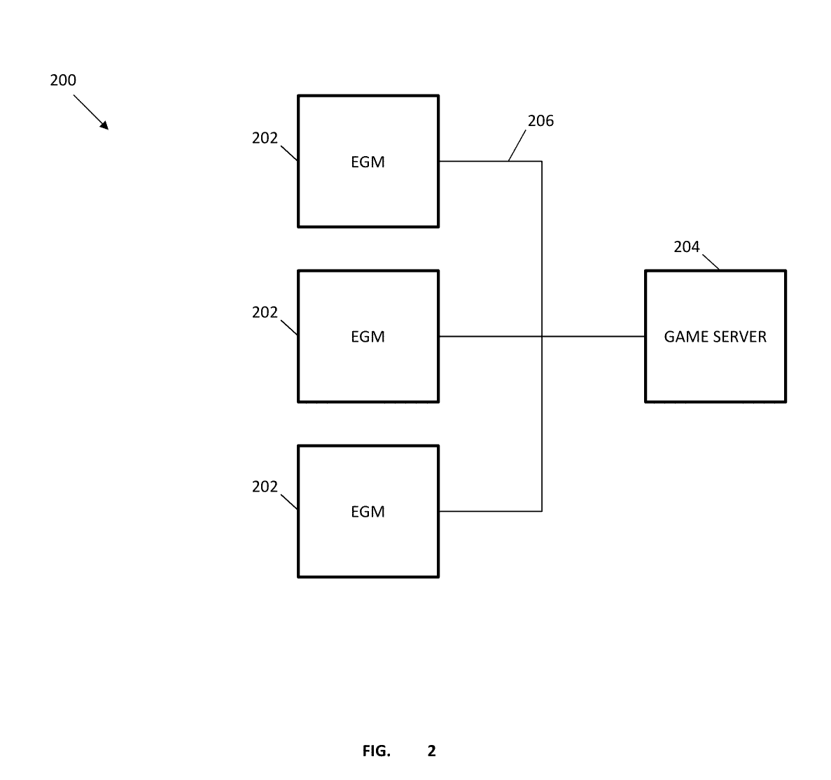

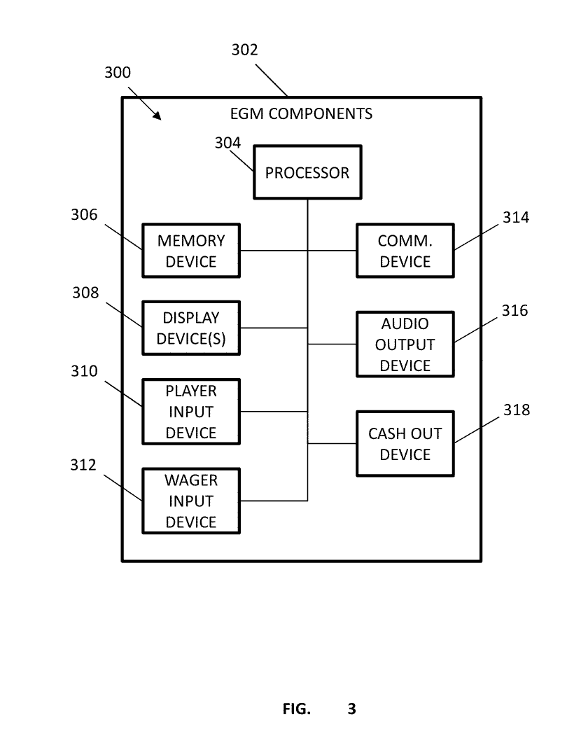

FIG. 2 is a block diagram of a system 200 that may be used to provide a wagering game to a plurality of players. In the example illustrated in FIG. 2, system 200 includes a plurality of electronic gaming machines (EGMs) 202 that are coupled to at least one server, such as a game server 204, via a network 206. Each EGM 202 may include a plurality of EGM components 300 that are illustrated and described with reference to FIG. 3. Game server 204 may include at least one processor (not shown) for controlling the operation of game server 204 and for performing the functions of game server 204 described herein.

Referring to FIG. 2, each EGM 202 may be operated by a respective player to play a wagering game, such as the three card flush game with optional side wagers described above with reference to FIG. 1. In one embodiment, the game is implemented on each EGM 202 while the gameplay of each EGM 202 is coordinated by game server 204 (i.e., by a processor of game server 204). Accordingly, each player may play the game on a respective EGM 202 in a networked manner with each other player playing on respective EGMs 202. Alternatively, the game may be implemented on game server 204 and may be communicated to each EGM 202 such that each EGM 202 may display game screens and may receive player inputs, wager inputs, and wagering decisions associated with the game. In both embodiments, each EGM 202 may transmit the player inputs, wager inputs, and wagering decisions to game server 204. The following embodiments are described in which the game is implemented on each EGM 202 with the understanding that the descriptions may also apply to the embodiment in which the game is implemented on game server 204 with appropriate modifications.

Each EGM 202 may be coupled to game server 204 to enable each player to play against each other using a respective EGM 202. Accordingly, each player may participate in a joint wagering game by entering inputs representative of wagers, wagering decisions, and gameplay decisions using interfaces of each EGM 202. The inputs of each player are transmitted to game server 204 as discussed in more detail herein. It should be recognized that the game may alternatively be played by a single player operating a single EGM 202 in communication with game server 204 to enable the player to play against the house as opposed to playing with other players.

Referring to FIG. 3, each EGM 202 may include a plurality of EGM components 300 positioned within a housing or cabinet 302, including a processor 304, a memory device 306, a display device 308, a player input device 310, a wager input device 312, a communication device 314, an audio output device 316, and a cash out device 318. Alternatively, one or more of the EGM components 300 may be combined together in some embodiments.

Processor 304 is used to control an operation of EGM 202. Processor 304 may include, for example, a microprocessor, a microcontroller-based platform, a suitable integrated circuit or one or more application-specific integrated circuits (ASIC's). Processor 304 may be a single core processor or a multi-core processor and may be capable of processing multiple threads simultaneously.

Memory device 306 includes one or more computer-readable media that may store computer-executable instructions that are executable by processor 304, for example, to perform the functions of EGM 202. Memory device 306 may also store data usable by processor 304 to implement the games described herein and/or to implement any of the other functions described herein. Memory device 306 may include random access memory (RAM), flash memory, one or more hard disks, and/or other forms of memory including electrically erasable programmable read only memory (EEPROM) or the like. The RAM memory may include non-volatile RAM (NVRAM), magnetic RAM (MRAM), or ferroelectric RAM (FeRAM), and/or any other suitable form of RAM.

Display device 308 may be secured to housing 202 to enable a player to view game content such as a virtual table of the wagering game as well as the cards and/or representations of the players playing the game. Display device 308 may include one or more monitors, televisions, projectors, plasma displays, liquid crystal displays (LCD), displays based on light emitting diodes (LEDs), displays based on a plurality of organic light-emitting diodes (OLEDs), or any other suitable electronic device or display mechanism. In one embodiment, display device 308 includes a touch-screen with an associated touch-screen controller. In a specific embodiment, display device 308 may include a first display coupled to a top portion of housing 202 and a second display positioned below the first display. The first display may display the gameplay of the wagering game and the second display may display other information related to the game or EGM 202, such as wager amounts, an amount of credits available to be used in the game, player reward status, and the like. Alternatively, the position or location of the content displayed on the first and second displays may be switched.

Player input device 310 may include one or more buttons, a keyboard, a mouse, a trackball, a joystick, a touch-screen, a microphone cooperating with a speech recognition module, an optical sensor cooperating with a gesture control device, and/or any other suitable device that enables a player to input data or commands into EGM 202. The player may use player input device 310 to input game play commands and to input wagering decisions during the game, for example.

Wager input device 312 may include an acceptor configured to receive a physical item associated with a monetary value. For example, wager input device 312 may include a bill acceptor configured to receive and identify paper currency input into EGM 202, a scanner configured to identify and read tickets or vouchers having an amount of currency or credits identified therein, an NFC reader configured to receive data representative of an amount of currency or credits to be input into EGM 202 from a mobile phone or other device, and/or any other suitable device that enables EGM 202 to receive an amount of currency or credits to be used during the game. Wager input device 312 may receive the physical item associated with a monetary value, may extract or identify the monetary value associated therewith, and may transmit data to processor 304 indicating the monetary value. In response, processor 304 may add the monetary value to a credit balance stored within EGM 202 for use in the game.

Communication device 314 enables EGM 202 to communicate with other EGMs 202 and/or with game server 204. Communication device 314 may include, for example, a wired Ethernet interface (e.g., using IEEE 802.3), a wireless Ethernet interface (e.g., using IEEE 802.11), a mesh network interface, a Bluetooth interface, a cellular or telephone modem, and/or any other suitable device that enables EGM 202 to communicate with game server 204. In one embodiment, communication device 314 transmits data to, and receives data from, game server 204 via a local area network (LAN), a wide area network (WAN), a casino area network (CAN), the Internet, the public switched telephone network (PSTN), and/or any other suitable network.

Audio output device 316 includes one or more speakers or other devices that enables EGM 202 to output audible and/or inaudible sounds to the player or to another suitable recipient. For example, EGM 202 may control audio output device 316 to generate audible game play sounds related to the game and/or to notify casino personnel about the status of EGM 202.

Cash out device 318 may include a bill dispenser, a coin dispenser, or a printer that prints vouchers or tickets having computer-readable indicia representing an amount of credits or currency dispensed to the player. In one embodiment, when a player operates player input device 310 to initiate a cash out operation on EGM 202, processor 304 transmits data to cash out device 318 to cause cash out device 318 to dispense one or more physical items representing the credit balance of the player on EGM 202. For example, processor 304 may transmit data to cash out device 318 indicating an amount of currency to dispense (i.e., corresponding to all or a selected portion of the player's credit balance), or may transmit data to cash out device 318 indicating an amount of currency or credits to print on a voucher that is presented to the player. Processor 304 decreases the credit balance of EGM 202 by the amount of currency or credits dispensed during the cash out operation.

During operation, a player may operate EGM 202 to play a wagering game, such as the three card flush game with optional side wagers, according to the embodiments described herein. In one embodiment, the game is played by a plurality of players playing on respective EGMs 202 and is centrally administered or coordinated by game server 204. Accordingly, the players may play against each other in a competitive game using their respective EGM 202.

The player may join the game by operating a button or other portion of player input device 310. In response, processor 304 transmits a signal to game server 204 and game server 204 causes the player to join the game along with two or more other players. As the game play progresses, each player inputs game play commands and wagering decisions using a respective player input device 310, and data representative of the player inputs are transmitted to game server 204. Game server 204, in turn, transmits data representative of each player's inputs and decisions to EGMs 202 associated with each other player to cause the respective EGM 202 to display the results of the inputs.

The game play of the three card flush game with optional side wagers is played using the EGMs 202 in the same manner as described above with reference to FIG. 1. After the wagering decisions have completed and the player hands have been formed with the community card, game server 204 may determine an award or prize to be provided to each player based on the winning hand matched by each player hand.

Each time a player enters a wagering decision through player input device 310 that involves an additional amount to be wagered (e.g., posting of the flush wager, the flush play wager, etc.), processor 304 reduces the player's available credit balance by the wagered amount. Conversely, if the player wins an award, processor 304 increases the player's credit balance by the amount awarded by game server 204. When the player has finished a play session on EGM 202, the player may cash out the remaining credit balance by initiating a cash out operation through player input device 310 (e.g., by pressing a cash out button or the like). In response, processor 304 causes cash out device 318 to dispense all or a selected portion of the credit balance to the player in the form of physical currency, a voucher or ticket identifying the credit balance, or another suitable representation of the credit balance. Processor 304 deducts the cashed out amount from the credit balance.

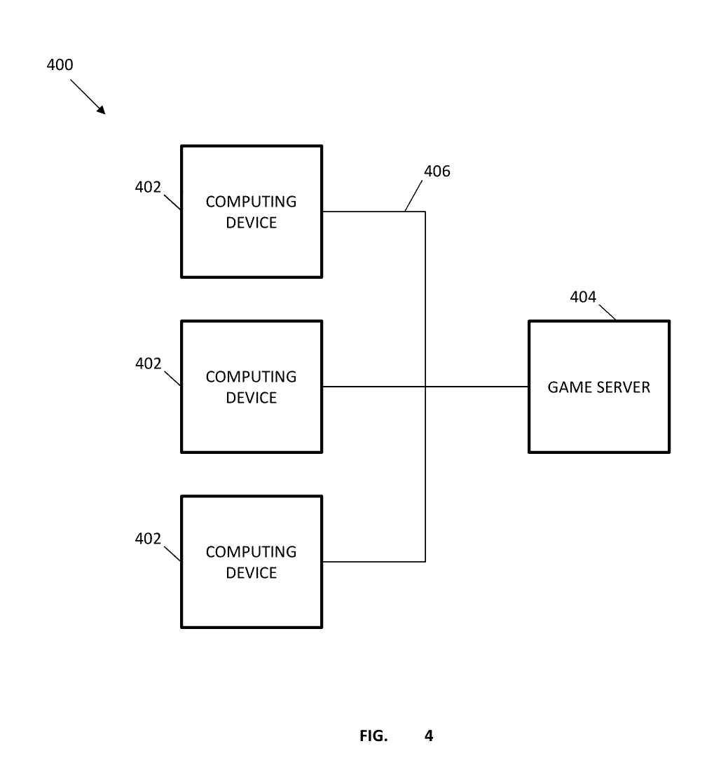

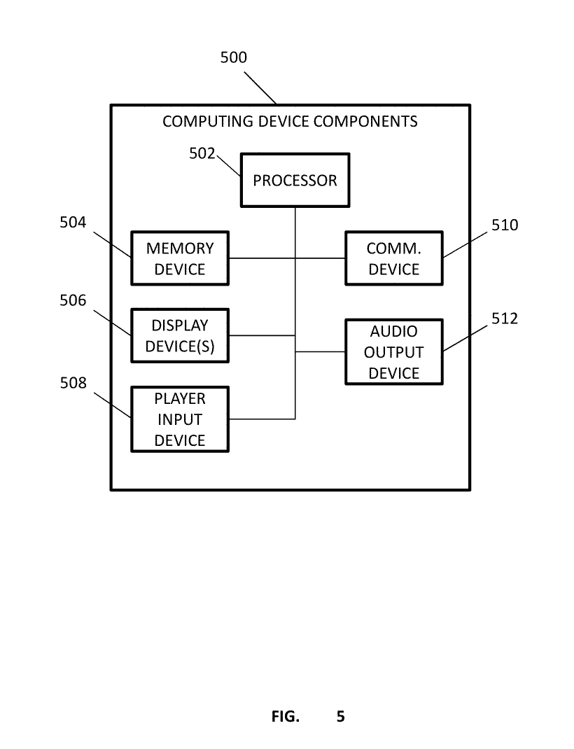

FIG. 4 is a block diagram of another system 400 that may be used to provide a wagering game to a plurality of players. In the example illustrated in FIG. 4, system 400 includes a plurality of computing devices 402 that are coupled to at least one server, such as a game server 404, via a network 406. In the embodiments described herein, computing devices 402 may interact with game server 404 to provide an online wagering game to the player of each computing device 402. Each computing device 402 may include a plurality of computing device components 500 that are illustrated and described with reference to FIG. 5. Game server 404 may include at least one processor (not shown) for controlling the operation of game server 404 and for performing the functions of game server 404 described herein.

Referring to FIG. 4, each computing device 402 may be operated by a respective player to play an online game of three card flush with optional side wagers as described above with reference to FIG. 1. In one embodiment, the game is implemented on each computing device 402 while the gameplay of each computing device 402 is coordinated by game server 404. Accordingly, each player may play the game on a respective computing device 402 in a networked manner with each other player playing on respective computing devices 402. Alternatively, the game may be implemented on game server 404 and may be communicated to each computing device 402 such that each computing device 402 may display game screens and may receive player inputs, wager inputs, and wagering decisions associated with the game. In both embodiments, each computing device 402 may transmit the player inputs, wager inputs, and wagering decisions to game server 404. The following embodiments are described in which the game is implemented on each computing device 402 with the understanding that the descriptions may also apply to the embodiment in which the game is implemented on game server 404 with appropriate modifications. It should be recognized that the game may alternatively be played by a single player operating a single computing device 402 in communication with game server 404 to enable the player to play against the house as opposed to playing with other players.

Each computing device 402 may be coupled to game server 404 to enable each player to play against each other using a respective computing device 402. Accordingly, each player may participate in a joint game of three card flush by entering inputs representative of wagers, wagering decisions, and gameplay decisions using player input devices of each computing device 402. The inputs of each player are transmitted to game server 404 as discussed in more detail herein.

Computing devices 402 may include, for example, one or more laptop computers, desktop computers, tablet computing devices, smart phones, wearable computing devices (e.g., smart watches or the like), or any other suitable computing device.

Referring to FIG. 5, each computing device 402 may include a plurality of computing device components 500, including a processor 502, a memory device 504, a display device 506, a player input device 508, a communication device 510, and an audio output device 512. Alternatively, one or more of the computing device components 500 may be combined together in some embodiments.

Processor 502 is used to control an operation of computing device 402. Processor 502 may include, for example, a microprocessor, a microcontroller-based platform, a suitable integrated circuit or one or more application-specific integrated circuits (ASIC's). Processor 502 may be a single core processor or a multi-core processor and may be capable of processing multiple threads simultaneously.

Memory device 504 includes one or more computer-readable media that may store computer-executable instructions that are executable by processor 502, for example, to perform the functions of computing device 402. Memory device 504 may also store data usable by processor 502 to implement the games described herein and/or to implement any of the other functions described herein. Memory device 504 may include random access memory (RAM), flash memory, one or more hard disks, and/or other forms of memory including electrically erasable programmable read only memory (EEPROM) or the like. The RAM memory may include non-volatile RAM (NVRAM), magnetic RAM (MRAM), or ferroelectric RAM (FeRAM), and/or any other suitable form of RAM.

Display device 506 may enable a player to view game content such as a virtual table of the wagering game as well as the cards and representations of the players playing the game. Display device 506 may include one or more monitors, televisions, projectors, plasma displays, liquid crystal displays (LCD), displays based on light emitting diodes (LEDs), displays based on a plurality of organic light-emitting diodes (OLEDs), or any other suitable electronic device or display mechanism. In one embodiment, as described in more detail below, display device 506 includes a touch-screen with an associated touch-screen controller. In a specific embodiment, display device 506 may display the gameplay of the wagering game and other information related to the wagering game, such as wager amounts, an amount of credits available to be used in the game, player reward status, and the like.

Player input device 508 may include one or more buttons, a keyboard, a mouse, a trackball, a joystick, a touch-screen, a microphone cooperating with a speech recognition module, an optical sensor cooperating with a gesture control device, and/or any other suitable device that enables a player to input data or commands into computing device 402. The player may use player input device 508 to input game play commands and to input wagering decisions during the game, for example.

Communication device 510 enables computing device 402 to communicate with other computing devices 402 and/or with game server 404 using one or more networks 406. Communication device 510 may include, for example, a wired Ethernet interface (e.g., using IEEE 802.3), a wireless Ethernet interface (e.g., using IEEE 802.11), a mesh network interface, a Bluetooth interface, a cellular or telephone modem, and/or any other suitable device that enables computing device 402 to communicate with game server 404. In one embodiment, communication device 510 transmits data to, and receives data from, game server 404 via a local area network (LAN), a wide area network (WAN), a casino area network (CAN), the Internet, the public switched telephone network (PSTN), and/or any other suitable network.

Audio output device 512 includes one or more speakers or other devices that enables computing device 402 to output audible and/or inaudible sounds to the player or to another suitable recipient. For example, computing device 402 may control audio output device 512 to generate audible game play sounds related to the game.

During operation, a player may operate computing device 402 to play a wagering game, such as the three card flush game with optional side wagers, according to the embodiments described herein. In one embodiment, the game is played by a plurality of players playing on respective computing devices 402 and is centrally administered or coordinated by game server 404. Accordingly, the players may play against each other or against the house in an online wagering game using their respective computing device 402.

The player may join the game by operating a button or other portion of player input device 508. In response, processor 502 transmits a signal to game server 404 and game server 404 causes the player to join the game along with one or more other players. The player may initially establish a credit balance for use in the game by operating computing device 402 to transfer money or credits from a debit or credit account, for example, to an account associated with the game. As the game play progresses, each player inputs game play commands and wagering decisions using a respective player input device 508, and data representative of the player inputs are transmitted to game server 404. Game server 404, in turn, transmits data representative of each player's inputs and decisions to computing devices 402 associated with each other player to cause the respective computing device 402 to display the results of the inputs.

In one embodiment, the specific game play of the three card flush game is substantially similar to the game play of the game described above with respect to FIG. 1. After the wagering decisions have completed and the player hands have been formed with the community card, game server 404 may determine an award or prize to be provided to each player based on the winning hand matched by each player hand.

Each time a player enters a wagering decision through player input device 508 that involves an additional amount to be wagered (e.g., posting of the flush wager, the flush play wager, etc.), processor 502 reduces the player's available credit balance by the wagered amount. Conversely, if the player wins an award, processor 502 increases the player's credit balance by the amount awarded by game server 404. When the player has finished a play session on computing device 402, the player may cash out the remaining credit balance by initiating a cash out operation through player input device 508 (e.g., by selecting a cash out icon, or the like). In response, processor 502 may cause all or a selected portion of the credit balance to be electronically transferred to an account of the player, such as a bank account. Processor 502 may then deduct the cashed out amount from the credit balance.

Although specific features of various embodiments of the disclosure may be shown in some drawings and not in others, this is for convenience only. In accordance with the principles of the disclosure, any feature of a drawing or other embodiment may be referenced and/or claimed in combination with any feature of any other drawing or embodiment.

This written description uses examples to describe embodiments of the disclosure and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electronic gaming machine comprising:
a wager input device that accepts a physical item associated with a monetary value;
a player input device configured to receive an input representative of a wager amount from a player operating the electronic gaming machine wherein the monetary value is added to a credit balance associated with the player and the wager amount is deducted from the credit balance;
a cash out device configured to dispense at least a portion of the credit balance in the form of a physical object;
a display device;
a processor configured to:
provide a wagering game to the player, wherein the wagering game includes a virtual table displayed on the display device;
receive an input associated with at least one required wager entered by the player;
deal a set of three player cards the player;
deal a community card to a community area of the virtual table, wherein the player is able to use the community card to form a player hand in conjunction with the set of player cards dealt to the player, and wherein a suit of the community card determines a hierarchy of winning player hands available to be formed by the player;
receive a wagering decision from the player;
determine whether the player hand matches one of a plurality of winning hands; and
determine an award to be received by the player based on the player hand matching one of the plurality of winning hands,
wherein the processor is further configured to:
add the award to the credit balance of the player;
receive an input from the player to initiate a cash out operation; and
cause the cash out device to dispense at least a portion of the credit balance in the form of a physical object.

2. The system of claim 1, wherein the player cards and the community card are dealt from a virtual, non-standard poker deck having 53 cards.

3. The system of claim 2, wherein the non-standard poker deck includes a standard set of 52 poker cards and one wild card that has a variable suit and rank.

4. The system of claim 3, wherein the wild card takes on the suit and rank of the community card when the white card is dealt to the player.

5. The system of claim 4, wherein the wild card has a fixed suit and rank when the white card is dealt as the community card.

6. The system of claim 1, wherein the at least one required wager includes two wagers that are required to be posted by the player before the player receives the player cards.

7. The system of claim 6, wherein the player is required to post a third wager after receiving the player cards in order to continue playing the game.

8. The system of claim 1, wherein processor is further configured to:
receive a side wager from the player;
provide a secondary award to the player upon a determination that the player hand includes a card that has the same suit as the community card and is a higher rank than the community card.

9. The system of claim 1, wherein the award is determined according to a first pay table, and wherein processor is further configured to:
receive a side wager from the player; and
provide a secondary award to the player upon a determination that the player hand includes a card that has the same suit as the community card, wherein the secondary award is determined according to a second pay table different than the first pay table.

10. A system, comprising:
a plurality of computing devices, each computing device comprising:
a player input device configured to receive an input representative of a wagering decision from a player operating the computing device;
a display device configured to display a wagering game including a virtual table; and
a processor configured to present the wagering game to the player on the display device; and
a server coupled to each of the plurality of computing devices, the server comprising a processor configured to:
provide the game to each computing device to cause each computing device of a plurality of computing devices to present the wagering game to a respective player of a plurality of players;
receive an input associated with at least one required wager entered by at least one player of the plurality of players;
deal three player cards to the player;
deal a community card to a community area of the virtual table, wherein the player is able to use the community card to form a player hand in conjunction with the set of player cards dealt to the player, and wherein a suit of the community card determines a hierarchy of winning player hands available to be formed by the player;
receive a wagering decision from the player;
determine whether the player hand matches one of a plurality of winning hands; and
determine an award to be received by the player based on the player hand matching one of the plurality of winning hands.

11. The system of claim 10, wherein the player cards and the community card are dealt from a virtual, non-standard poker deck having 53 cards.

12. The system of claim 11, wherein the non-standard poker deck includes a standard set of 52 poker cards and one wild card that has a variable suit and rank.

13. The system of claim 12, wherein the wild card takes on the suit and rank of the community card when the white card is dealt to the player.

14. The system of claim 13, wherein the wild card has a fixed suit and rank when the white card is dealt as the community card.

15. The system of claim 10, wherein the at least one required wager includes two wagers that are required to be posted by the player before the player receives the player cards.

16. The system of claim 15, wherein the player is required to post a third wager after receiving the player cards in order to continue playing the game.

17. The system of claim 10, wherein processor is further configured to:
receive a side wager from the player;
provide a secondary award to the player upon a determination that the player hand includes a card that has the same suit as the community card and is a higher rank than the community card.

18. The system of claim 10, wherein the award is determined according to a first pay table, and wherein processor is further configured to:
receive a side wager from the player; and
provide a secondary award to the player upon a determination that the player hand includes a card that has the same suit as the community card, wherein the secondary award is determined according to a second pay table different than the first pay table.

19. A method of providing a wagering game to a plurality of players, the method comprising:
receiving at least one required wager from a first player at a table;
receiving a second required wager from a second player at the table;
dealing three player cards to each of the first player and the second player;
dealing a community card to a community area of the table, wherein the first player is able to use the community card to form a first player hand in conjunction with the player cards dealt to the first player and the second player is able to use the community card to form a second player hand in conjunction with the player cards dealt to the second player, and wherein a suit of the community card determines a hierarchy of winning player hands available to be formed by the first player and the second player;
receiving a wagering decision from each of the first player and the second player;
determining whether the first player hand matches one of a plurality of winning hands;
determining whether the second player hand matches one of the plurality of winning hands;
determining an award to be received by the first player based on the first player hand matching one of the plurality of winning hands; and
determining an award to be received by the second player based on the second player hand matching one of the plurality of winning hands.

20. The system of claim 19, wherein the player cards and the community card are dealt from a virtual, non-standard poker deck having 53 cards.
